(19) United States
(12) Patent Application Publication
(10) Pub. No.: US 2014/0099210 A1
(43) Pub. Date: Apr. 10, 2014

(54) SYSTEM FOR GAS TURBINE ROTOR AND SECTION COUPLING

(71) Applicant: GENERAL ELECTRIC COMPANY, Schenectady, NY (US)

(72) Inventor: Christopher Edward Miller, Fletcher, NC (US)

(73) Assignee: GENERAL ELECTRIC COMPANY, Schenectady, NY (US)

(21) Appl. No.: 13/648,272

(22) Filed: Oct. 9, 2012

(51) Int. Cl. F01D 5/06; F01D 5/18; B23P 19/04

(52) U.S. Cl. 416/96 R; 416/198 A; 416/146 R

(57) ABSTRACT

A system, including a first turbomachine rotor disk, a first annular protrusion with a first spline coupled to the first turbomachine rotor disk, a second turbomachine rotor disk, and a second annular protrusion with a second spline coupled to the second turbomachine rotor disk, wherein the first and second splines are coupled to one another.

### BACKGROUND OF THE INVENTION

The subject matter disclosed herein relates to gas turbine engines and, more specifically, to a system for joining compressor rotors; turbine rotors; and sections of turbines and compressors.

Gas turbine systems combust a fuel-air mixture to create rotational energy that drives a load or creates thrust. A compressor uses a series of rotor disks to progressively compress air that then mixes with fuel. This fuel-air mixture combusts and flows through a turbine causing a series of turbine rotor disks to spin. The series of compressor and turbine rotor disks transmit torque between neighboring rotor disks as they spin. Current rotor disks designs may connect to each other in ways that complicate field maintenance and repair; and that are less effective in transmitting torque.

### BRIEF DESCRIPTION OF THE INVENTION

Certain embodiments commensurate in scope with the originally claimed invention are summarized below. These embodiments are not intended to limit the scope of the claimed invention, but rather these embodiments are intended only to provide a brief summary of possible forms of the invention. Indeed, the invention may encompass a variety of forms that may be similar to or different from the embodiments set forth below.

In a first embodiment, a system, including a first turbomachine rotor disk, a first annular protrusion with a first spline coupled to the first turbomachine rotor disk, a second turbomachine rotor disk, and a second annular protrusion with a second spline coupled to the second turbomachine rotor disk, wherein the first and second splines are coupled to one another.

In a second embodiment, a system including, a gas turbine engine including a first rotor disk, wherein the first rotor disk includes a first annular protrusion with a first spline, and a second rotor disk, wherein the second rotor disk includes a second annular protrusion with a second spline, wherein the first and second splines are coupled to one another.

In a third embodiment a rotor disk coupling kit including, a first turbomachine rotor disk with a first and second axial sides, a first annular protrusion with at least one spline coupled to the first turbomachine rotor disk on the first axial side and a second annular protrusion with at least one spline coupled to the first turbomachine rotor disk on the first axial side.

### BRIEF DESCRIPTION OF THE DRAWINGS

These and other features, aspects, and advantages of the present invention will become better understood when the following detailed description is read with reference to the accompanying drawings in which like characters represent like parts throughout the drawings, wherein:

FIG. 1 is a block diagram of an embodiment of a gas turbine;

FIG. 2 is a partial cross-sectional view of two rotor disks along line 2-2 in an unmated position;

FIG. 3 is a cross-sectional view of the two rotor disks in FIG. 2 in a mated position;

FIG. 4 is a rear view of a rotor disk along section line 4-4 of FIG. 1, illustrating two annular protrusions;

FIG. 5 is a front view of a rotor disk with multiple annular protrusions;

FIG. 6 is a side view of two rotor disks along section line 6-6 of FIG. 1, and a tool that separates and joins rotor disks according to the present embodiment;

FIG. 7 is a block diagram of an embodiment of a gas turbine system with separable compressor and turbine sections; and

FIG. 8 is a side view of two compressor or turbine sections in an unmated position along section line 8-8.

### DETAILED DESCRIPTION OF THE INVENTION

One or more specific embodiments of the present invention will be described below. In an effort to provide a concise description of these embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present invention, the articles “a,” “an,” “the,” and “said” are intended to mean that there are one or more of the elements. The terms “comprising,” “including,” and “having” are intended to be inclusive and mean that there may be additional elements other than the listed elements.

The present disclosure is generally directed towards gas turbine rotor disks and gas turbine sections that connect using splines. More specifically, the turbine rotor disks and compressor rotor disks connect to each other using annular protrusions on the rotor disks. The annular protrusions include splines that interlock with splines on other rotor disk protrusions. These connections advantageously make it easier to connect a series of rotor disks, improve torque transmission between rotor disks, and control thermally induced run out imbalance. In some embodiments, the rotor disks may include more than one annular protrusion to further improve torque transmission and reduce thermally induced run out imbalance. The annular protrusions may be concentric with the rotor disk or placed at distinct locations on the rotor disk. Furthermore, the protrusions may include a conical feature that enables centering and radial alignment, ensuring that the splines on the different rotor disks properly interlock. In some embodiments, the rotor disks may include a tool slot. The tool slot allows a tool to assist in separating rotor disks (e.g., rotor disks that have excessive corrosion or oxidization, etc.) in a field environment eliminating or reducing the need to ship the entire compressor or turbine to a distant shop in order to separate the rotor disks. In addition, the present disclosure discloses a modular compressor and turbine formed from multiple sections. These sections may connect using a spline connection. The modular design of the compressor and turbine may advantageously assist in shipping the compressors and turbines (e.g., shipping in portions), assembly in the field, and the replacement of broken and worn out parts (e.g., by replacing a section instead of the entire compressor or turbine).

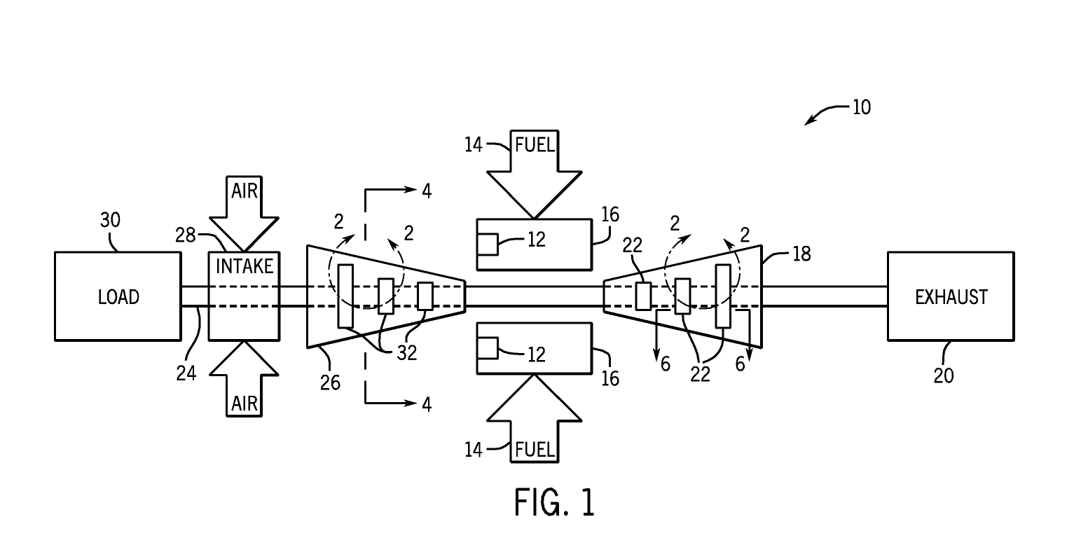

FIG. 1 is a block diagram of an embodiment of a gas turbine system 10 having rotor disks that connect to one another using protrusions with splines. These protrusions with splines effectively transmit torque, control thermal run out imbalance, radially center the rotor disks, and enable field maintenance and support. The turbine system 10 may use liquid or gas fuel, such as natural gas and/or a hydrogen rich synthetic gas, to run the turbine system 10. As depicted, a plurality of fuel nozzles 12 intakes a fuel supply 14, mixes the fuel with air, and distributes the air-fuel mixture into a combustor 16. The air-fuel mixture combusts in a chamber within combustor 16, thereby creating hot pressurized exhaust gases. The combustor 16 directs the exhaust gases through a turbine 18 toward an exhaust outlet 20. As the exhaust gases pass through the turbine 18, the gases contact turbine blades attached to turbine rotor disks 22 (e.g., turbine stages). As illustrated, there are three turbine stages or rotor disks 22, but other embodiments may include different numbers of turbine stages or rotor disks 22 (e.g., 1, 2, 3, 4, 5, 10, or more). The turbine rotor disks 22 engage one another with splines that effectively align and transmit torque between the rotor disks 22. The torque forces one or more turbine blades to rotate the rotor disks 22 along an axis of the system 10. The rotation of the turbine rotor disks 22 causes rotor disks in the compressor 26 to rotate. As the rotor disks in the compressor 26 rotate they draw in and compress air from an air intake 28. The compressed air travels through the compressor 26 and into the fuel nozzles 12 and/or combustor 16. The rotation of the rotor disks in the compressor 26 and/or turbine 18 may rotate a shaft 24 connected to a load 30, which may be a vehicle or a stationary load, such as an electrical generator in a power plant or a propeller on an aircraft, for example. As will be understood, the load 30 may include any suitable device capable of being powered by the rotational output of turbine system 10.

In operation, air enters the turbine system 10 through the air intake 28 and may be pressurized in a series of compressor stages (e.g., rotor disks 32) in the compressor 26. As illustrated, there are three compressor stages (e.g., rotor disks 32), but other embodiment may include different numbers of compressor stages (e.g., rotor disks 32) (e.g., 1, 2, 3, 4, 5, 10, or more). The compressor stages (e.g., rotor disks 32) may connect to one another with splines that effectively align and transmit torque between the rotor disks. The compressed air may then mix with gas for combustion within combustor 16. For example, the fuel nozzles 12 may inject a fuel-air mixture into the combustor 16 in a suitable ratio for optimal combustion, emissions, fuel consumption, and power output. The combustion generates hot pressurized exhaust gases, which then drive one or more blades connected to one or more turbine rotor disks 22 within the turbine 18 that then rotate the rotor disks 32 in the compressor 26, and thus the load 30. Accordingly, the rotation of the turbine rotor disks 22 causes a rotation of the compressor stages or rotor disks 32 (e.g., compressor blades) that then draw in and pressurize the air received by the intake 26.

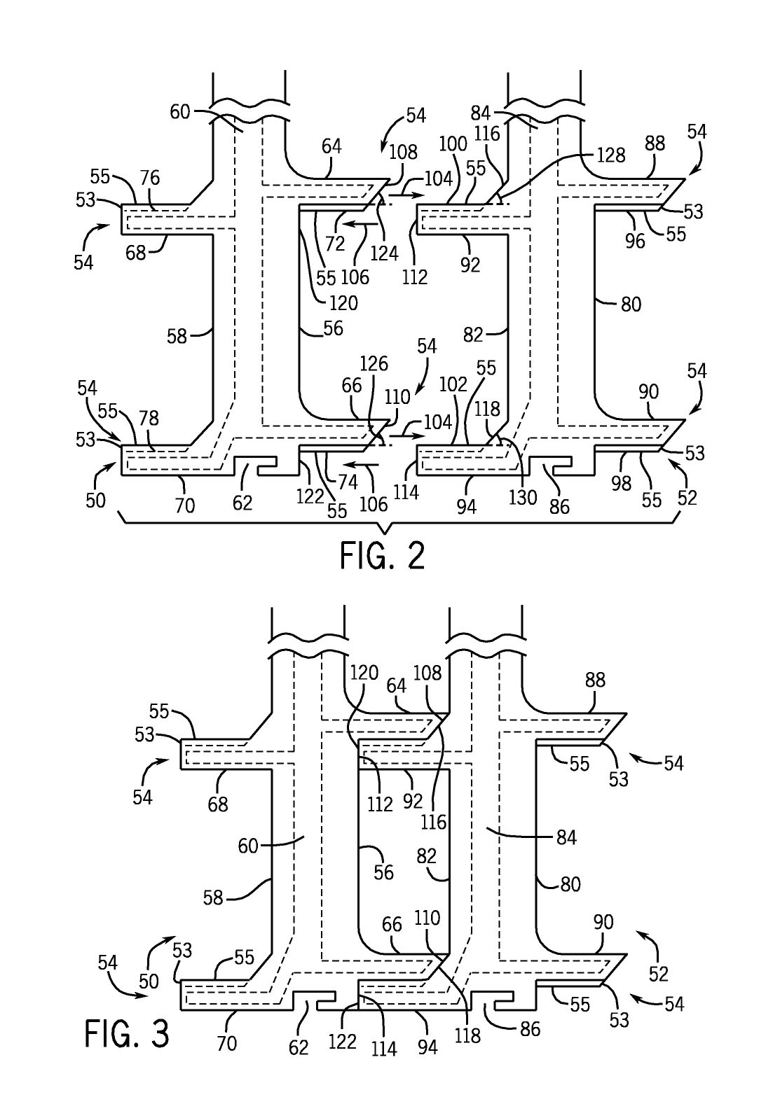

FIG. 2 is a cross-sectional view of two rotor disks 50 and 52 within line 2-2 of FIG. 1 in an unmated position. The rotor disks 50 and 52 may be either turbine rotor disks 22 or compressor rotor disks 32 and include annular protrusions 54, each comprising a plurality of axial teeth 53 arranged circumferentially about a longitudinal axis of the rotor disks 50 and 52. Each set of teeth 53 may define a spline 55. These annular protrusions 54 (e.g., equipped with teeth 53 of splines 55) may be at different radii that advantageously enable redundant connections between the rotor disks, assists in radially aligning the rotor disks during connection, effectively transmits torque, and controls thermal run out imbalance. The splines 55 equipped protrusions 54 may be welded, forged, machined, cast, bolted, or joined in any other way as part of the rotor disks 50 and 52. The rotor disk 50 defines a front face 56, a rear face 58, cooling slot 60, and tool slot 62. As illustrated, the front face 56 and the rear face 58 respectively include two annular protrusions 54. In other embodiments, the faces 56 and 58 may include different numbers of protrusions (e.g., 1, 2, 3, 4, 5, 6, 7, or more annular protrusions). The front face 56 includes an outer diameter annular protrusion 64 an inner diameter annular protrusion 66, while the rear face 58 includes an outer diameter protrusion 68 and an inner diameter protrusion 70 that are offset from the protrusions 64 and 66 on the front face 56. The protrusions 64, 66, 68, and 70 include respective splines, 55 (e.g., 72, 74, 76, and 78), each having a plurality of axial teeth 53 spaced circumferentially about the axis).

The rotor disk 52 similarly includes a front face 80, a rear face 82, cooling slot 84, and a tool slot 86. The front face 80 includes an annular outer diameter protrusion 88 and an annular inner diameter protrusion 90. The rear face includes an annular outer diameter protrusion 92 and an annular inner diameter protrusion 94. In other embodiments, the faces 80 and 82 may include different numbers of protrusions (e.g., 1, 2, 3, 4, 5, 6, 7, or more annular protrusions). The annular protrusions 88, 90, 92, and 94 include respective splines 55 (e.g., 96, 98, 100, and 102), each having a plurality of teeth 53. As illustrated, the rotor disks 50 and 52 connect to one another by moving the rotor disk 50 in axial direction 104 and the rotor disk 52 in axial direction 106. The axial movement of the rotor disks 50 and 52 brings the annular protrusions 64 and 66 of rotor disk 50 into contact with the annular protrusions 92 and 94 of rotor disk 52. More specifically, the annular protrusions 64 and 66 define a respective radius that is less than the radii of the protrusions 92 and 94. The differences in the radii allow the protrusions 64, 66, 92, and 94 to axially overlap, so that the splines 72 and 100 and the splines 74 and 102 interlock with one another creating a secure connection between the rotor disks 50 and 52.

In order to center and align the rotor disks 50 and 52, the annular protrusions 64 and 66 may advantageously include a tapered guide feature, such as a tapered annular surface or conical surface. In the present embodiment, the protrusions 64 and 66 include respective angled surfaces 108 and 110 (e.g., conical surfaces or tapered annular surface) that facilitate alignment and centering of the rotor disks 50 and 52. The angled surfaces 108 and 110 may contact and slide past the surfaces 112 and 114 on the protrusions 92 and 94, thus aligning and centering the protrusions 64 and 66 with the protrusions 92 and 94. The protrusions 64 and 66 continue sliding over the protrusions 92 and 94 until the angled surfaces 108 and 110 contact the angled surfaces 116 and 118 of the rear face 82 on rotor disk disk 52. Simultaneously, the protrusions 92 and 94 continue sliding past the protrusions 64 and 66 until surfaces 112 and 114 contact the surfaces 120 and 122 of the front face 56 on rotor disk 50. As illustrated, the angled surfaces 108 and 110 form angles 124 and 126. The angles 124 and 126 correspond to angles 128 and 130 on the rotor disk 52. These angles 124, 126, 128, and 130 may be approximately within 1-89, 5-45, 10-35, 15-25, 20-70, or 30-60 degrees. In other embodiments, the surfaces 112, 114, 120, and 122 may also be angled for radial centering (e.g., to align rotational axes with one another) and alignment of the protrusions 92 and 94. In still other embodiments, the protrusions 92 and 94 may radially align the rotor disks 50 and 52 by angling surfaces 112, 114, 120, and 122 instead of the protrusions 64 and 66.

FIG. 3 is a cross-sectional view of the two rotor disks 50 and 52 in FIG. 2 in a mated position. Once joined, the spline protrusion 64 and 66 overlap with the equipped protrusions 92 and 94. In particular, the spline protrusions 64 and 66 overlap the equipped protrusions 92 and 94 until the angled surfaces 108 and 110 contact the angled surfaces 116 and 118; and the contact surfaces 120 and 122 contact the protrusion surfaces 112 and 114. The overlap of the spline protrusions 54 and their contact with the front face 56 and rear face 82 advantageously enable torque transmission through the interlocking splines 53, and friction with the faces 56 and 82. While not shown, the remaining 55 protrusions on the rotor disks 50 and 52 (i.e., 68, 70, 88, and 90) connect to neighboring rotor disks in the same way described above with respect to spline protrusions 64, 66, 92, and 94. Accordingly, a series of rotor disks may advantageous transmit torque through friction and interlocking splines 55 in the turbine 18 and the compressor 26.

As illustrated, the spline 55 equipped protrusions 54 are at different radii on the rotor disks 50 and 52, in order to overlap one another. However, the radii of the spline 55 equipped protrusions 54 may change in order to vary how the protrusions 54 overlap one another. In the present embodiment, the spline 55 equipped protrusions 92 and 94 are at smaller radii on the rotor disk 52 than the radii of the protrusions 64 and 66 on rotor disk 50. In other embodiments, the reverse may occur to position the spline 55 equipped protrusions 64 and 66 at smaller radii than the spline 55 equipped protrusions 92 and 94. In still other embodiments, the protrusions 64 may be at a larger radius than the protrusion 92, while the protrusion 66 is at a smaller radius than the protrusion 94.

As explained above, the rotor disks 50 and 52 may include the cooling passages 60 and 84. The cooling passages 60 and 84 advantageously move cooling air through the rotor disks 50 and 52 and into the protrusions 54, thereby cooling the protrusions 54 and reducing thermal expansion. The cooling passages 60 and 84 therefore advantageously reduce thermal expansion and the associated problem of thermally induced run out imbalance, thus improving torque transmission. In some embodiments, the protrusions 54 may include apertures that allow the cooling air to flow through the slots 60 and 84 and out of the protrusions 54, thus effectively circulating cooling air through the protrusions 54.

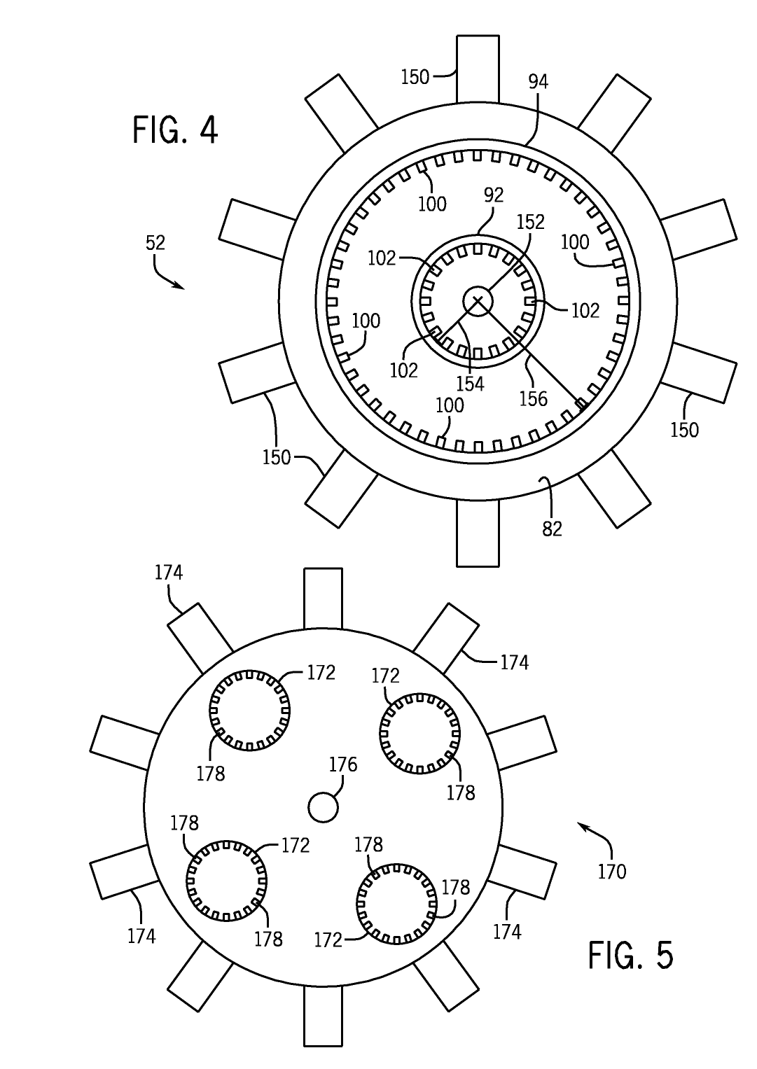

FIG. 4 is a view along section line 4-4 of FIG. 1, illustrating the rear face 82 of rotor disk 52 with annular protrusions 92 and 94 equipped with splines 55. As illustrated, the rotor disk 52 includes turbomachinery blades 150, spline 55 equipped annular protrusion 92, spline 55 equipped annular protrusion 94, and tool aperture 152. The rotor disk 52 could be a turbine rotor disk 22 or a compressor rotor disk 32 or other rotor member. The rotor disks in the turbine 18 and the compressor 26 may advantageously engage one another with spline 55 equipped protrusions (e.g., 92 and 94) that easily connect to one another and transmit torque. As illustrated, the rotor disk 52 advantageously includes two annular concentric protrusions 92 and 94 with respective splines 100 and 102. In other embodiments, the rotor disks 52 may include different numbers of protrusions (e.g., 1, 2, 3, 4, 5, 6, 7, 8, 9, 10 or more) each having a spline 55. Because rotor disk 52 includes more than one protrusion 54, it may more effectively transmit torque, maintain better contact with neighboring rotor disks, and reduce thermal run out imbalances from thermal expansions in high temperature environments.

As illustrated, the two spline 55 equipped protrusions 92 and 94 are at different radii, e.g., an inner radius and an outer radius. The protrusion 92 is at radius 154, while the protrusion 94 is at radius 156. Depending on the embodiment, the radii 154 and 156 may change (i.e., decrease or increase). Moreover, the illustrated protrusions 92 and 94 include splines 100 and 102 that face inward. In other embodiments, the splines 100 and 102 may change orientation by facing radially inward or outward. For example, in some embodiments, the splines 100 and 102 may face radially outward from the protrusions 92 and 94. In other embodiments, splines 100 may face radially inward while the splines 102 face radially outward. In still other embodiments, splines 100 may face radially outward while the splines 102 face radially inward. Regardless of whether the protrusions 92 and 94 face radially outwards or inwards, the protrusions 92 and 94 and their splines 100 and 102 provide an effective way for joining other rotor members and transmitting torque between turbine rotor disks 22 and compressor rotor disks 32.

FIG. 5 is a front view of a rotor disk 170 with multiple spline 55 equipped annular protrusions 172. As illustrated, the rotor disk 170 includes annular protrusions 172, blades 174, and a tool aperture 176. The annular protrusions 172 are not concentric with a radius of the rotor disk 170, but still advantageously enable simple and effective joining of rotor disks, torque transfer, and reduced thermal run out imbalance. As illustrated, the protrusions 172 are located at different points on the rotor disk 170. In the present embodiment, there are four protrusions 172, but other embodiments may include 1, 2, 3, 4, 5, 6, 7, 8, or more protrusions. The protrusions 172 include splines 178 that allow the rotor disk 170 to connect to another rotor disk in either the turbine 18 or the compressor 26. More specifically, the splines 178 of the protrusions 172 will interlock with splines 55 on a corresponding protrusion on an adjacent rotor disk, in a manner similar to that discussed in FIGS. 2 and 3.

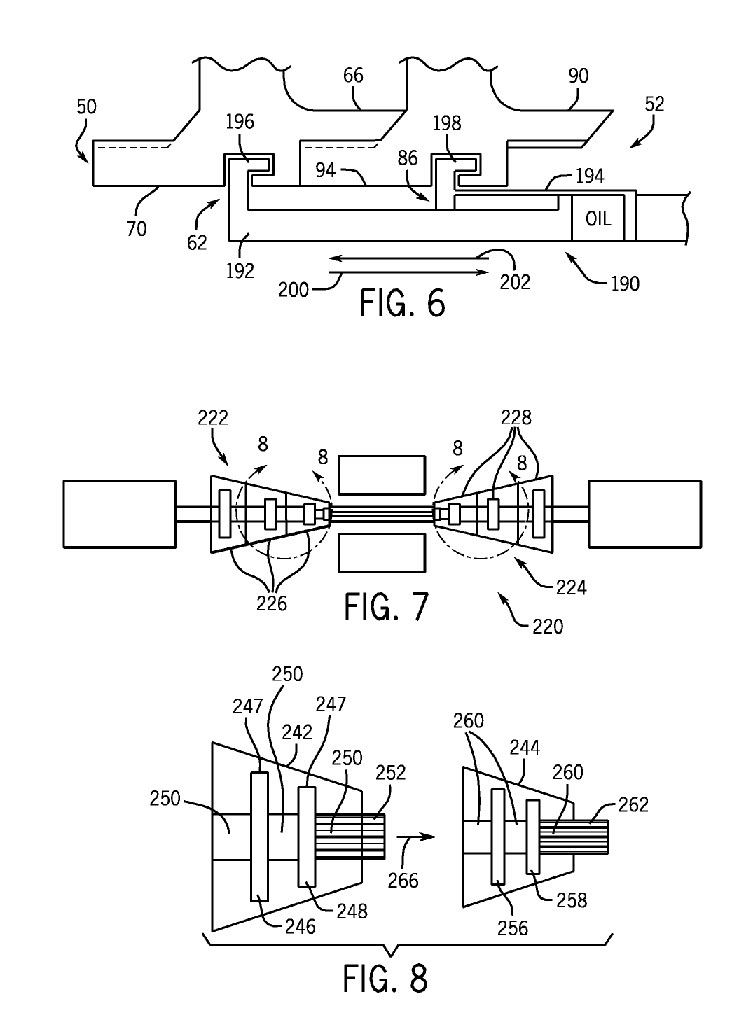

FIG. 6 is a side view along section line 6-6 of FIG. 1, illustrating a tool 190 that separates and joins rotor disks 50 and 52 according to the present embodiment. As explained above, the rotor disks 50 and 52 include spline 55 equipped protrusions 54 that advantageously enable the rotor disks to connect and separate in the field, thus avoiding the need to ship the gas turbine system 10 to a shop. The tool 190 advantageously assists in separating the rotor disks 50 and 52, which may be difficult to separate after extended use (e.g., oxidization). The tool 190 may be a hydraulic tool with a first annular member or cylinder 192, and a second annular member or cylinder 194 that surrounds the first annular member or cylinder 192. The first and second cylinders 192 and 194 include respective rotor disk engaging arms 196 and 198 for engaging tool slots on rotor disks. In operation, the engaging arms 196 and 198 connect to the tool slots 62 and 86 on the rotor disks 50 and 52. After inserting the arms 196 and 198 into the slots 62 and 86, the hydraulic tool 190 may actuate forcing the second cylinder 194 in direction 200 and the first cylinder 192 in direction 202. The movement of the first and second cylinders 192 and 194 in opposite directions separates the protrusions 54 of the rotor disks 50 and 52. The separation of the rotor disks 50 and 52 enables replacement of rotor disks (e.g., damaged or worn out rotor disks) and/or maintenance in the turbine 18 or compressor 26 in a field environment.

FIG. 7 is a block diagram of an embodiment of a gas turbine system 220 with a modular (i.e., sectional) compressor 222 and turbine 224. The modular design of the compressor 222 and turbine 226 may advantageously enable ease in shipping large compressors and turbines, assembly in the field, and the ability to replace broken and worn out parts by replacing a section instead of the entire compressor 222 or turbine 224. As illustrated, the compressor 222 and turbine 224 include respective compressor sections 226 and turbine sections 228 that connect to each other with splines. In the present embodiment, there are three compressor sections 226 and three turbine sections 228. In other embodiments, there may be a different number of compressor sections 226 or turbine sections 228 (e.g., 2, 3, 4, 5, 6, 7, 8, 9, 10, 11, 12, 13, 14, 15, or more). The sections 226 and 228 advantageously include a portion of the turbomachinery components (i.e., blades, rotor disks, etc.) for a compressor 222 and turbine 224. After assembly, the different sections 226 and 228 form an operational compressor 222 and turbine 224.

FIG. 8 is a side view of two sections 242 and 244 in an unmated position taken with section line 8-8 of FIG. 7. The sections 242 and 244 may be either compressor sections 226 or turbine sections 228. The two sections 242 and 244 may use a spline coupling for connection. The section 242 includes rotor disks 246 and 248, (e.g., turbomachinery stages with a plurality of blades) and spacers 250. In the present embodiment, the section 242 has two rotor disks 246 and 248. In other embodiments, the section 242 may include different numbers of rotor disks or turbomachinery stages (e.g., 1, 2, 3, 4, 5, 6, 7, 8, or more). The spacers 250 may include splines that couple with spline containing protrusions on the rotor disks 246 and 248. Moreover, a spacer 250 may enable the section 242 to connect to another section (e.g., section 244). Like section 242, the section 244 includes rotor disks 256 and 258 (e.g., turbomachinery stages with a plurality of blades); and spacers 260. The spacers 260 may include splines for coupling with spline containing protrusions on the rotor disks 256 and 258. In the present embodiment, the sections 242 and 244 are capable of connecting to one another with the spline containing spacer 250 and the spline containing spacer 260. Specifically, the section 242 moves in axial direction 266 until the splines 252 of the spacer 250 engage the splines of the spacer 260. In this manner, modular turbine sections 228 and compressor sections 226 may advantageously connect to one another to form a complete compressor 222 or turbine 224. In still other embodiments, the sections 242 and 244 may connect to one another with spline containing protrusions on the rotor disks 248 and 256, without spacers 250 and 260, like that discussed above in FIGS. 2-6. Moreover, and as discussed above, the rotor disks within each of the sections 242 and 244 may connect to each other using spline containing protrusions without the spacers 250 or 260.

Technical effects of the invention include the ability to connect rotor disks in a turbomachine (e.g., a turbine or compressor) using protrusions with splines. The spline containing protrusions advantageously improve torque transmission, control of thermal run out imbalance, and enable field serviceability (i.e., connection and separation) of the rotor disks. Furthermore, the protrusions may include a conical feature for aligning and centering the rotor disks during connection, and a tool slot to assist in separating the rotor disks. A tool may therefore engage the tool slots and separate the rotor disks in the field for maintenance purposes (e.g., repair or replacement of rotor disks). Finally, the compressor and turbine may include multiple sections (e.g., modular spline equipped units with one or more turbomachinery stages). A turbine or compressor formed from multiple sections enables ease in shipping large compressors and turbines (i.e., by shipping them in smaller sections), assembly in the field, and the ability to replace broken and worn out parts by replacing the section instead of the entire compressor or turbine.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

1. A system, comprising:
a first turbomachine rotor disk;
a first annular protrusion with a first spline coupled to the first turbomachine rotor disk;
a second turbomachine rotor disk; and
a second annular protrusion with a second spline coupled to the second turbomachine rotor disk, wherein the first and second splines are coupled to one another.

2. The system of claim 1, comprising a turbomachine having the first and second turbomachine rotor disks.

3. The system of claim 2, wherein the turbomachine comprises a gas turbine engine, and the first and second turbomachine rotor disks are disposed in a turbine section or a compressor section of the gas turbine engine.

4. The system of claim 1, comprising a first turbomachine module having a first set of turbomachine stages and a second turbomachine module having a second set of turbomachine stages, wherein the first turbomachine module has the first turbomachine rotor disk with the first protrusion equipped with the first spline, and the second turbomachine module has the second turbomachine rotor disk with the second protrusion equipped with the second spline.

5. The system of claim 1, wherein the first turbomachine rotor disk includes a third annular protrusion with a third spline and the second turbomachine rotor disk includes a fourth annular protrusion with a fourth spline, the first and third annular protrusions extend from a first axial side of the first turbomachine rotor disk, and the second and fourth annular protrusions extend from a second side of the second turbomachine rotor disk.

6. The system of claim 5, wherein the first and third annular protrusions are concentric with one another at a first radial offset, and the second and fourth annular protrusions are concentric with one another at a second radial offset.

7. The system of claim 5, wherein the first and third annular protrusions are concentric with the first rotor disk, and second and fourth annular protrusions are concentric with second rotor disk.

8. The system of claim 1, wherein the first and second turbomachine rotor disks include first and second tool slots, respectively.

9. The system of claim 8, comprising a tool configured to engage the first and second tool slots of the first and second turbomachine rotor disks.

10. The system of claim 1, wherein at least one of the first or second annular protrusions includes a guiding taper portion configured to align the first and second protrusions on the respective first and second annular turbomachine rotor disks.

11. The system of claim 1, wherein the first and second turbomachine rotor disks include cooling passages.

12. The system of claim 11, wherein the cooling passages travel through the first and second protrusions.

13. A system, comprising:
a gas turbine engine comprising:
a first rotor disk, wherein the first rotor disk includes a first annular protrusion with a first spline; and
a second rotor disk, wherein the second rotor disk includes a second annular protrusion with a second spline, wherein the first and second splines are coupled to one another.

14. The system of claim 13, wherein the gas turbine engine includes a compressor having the first and second rotor disks.

15. The system of claim 13, wherein the gas turbine engine includes a turbine having the first and second rotor disks.

16. The system of claim 13, wherein the first rotor disk includes a third annular protrusion with a third spline and the second rotor disk includes a fourth annular protrusion with a fourth spline, the first and third annular protrusions extend from a first axial side of the first rotor disk, and the second and fourth annular protrusions extend from a second side of the second rotor disk.

17. The system of claim 17, wherein at least one of the first or second annular protrusions includes a guiding taper portion configured to align the first and second protrusions on the respective first and second rotor disks.

18. A rotor disk coupling kit comprising:
a first turbomachine rotor disk with a first and second axial sides;
a first annular protrusion with at least one spline coupled to the first turbomachine rotor disk on the first axial side; and
a second annular protrusion with at least one spline coupled to the first turbomachine rotor disk on the first axial side.

19. The kit of claim 18, further comprising a second turbomachine rotor disk with a first and second axial sides, a third annular protrusion with at least one spline coupled to the second turbomachine rotor disk on the second axial side; and a fourth annular protrusion with at least one spline coupled to the second turbomachine rotor disk on the second axial side.

20. The kit of claim 18, wherein the first and second annular protrusions are concentric with the first turbomachine rotor disk, and third and fourth annular protrusions are concentric with second turbomachine rotor disk.

21. The kit of claim 18, wherein the first and second annular protrusions are not concentric with the first turbomachine rotor disk, and third and fourth annular protrusions are not concentric with second turbomachine rotor disk.

22. The kit of claim 18, further comprising a tool with a first and second piston, the first and second pistons including respective first and second arms, and wherein the tool is configured to join and separate the first and second turbomachine rotor disks by engaging a first and second slot on the respective first and second turbomachine rotor disks.
